(19) United States
(12) Patent Application Publication
(10) Pub. No.: US 2020/0092180 A1
(43) Pub. Date: Mar. 19, 2020

(54) METHODS AND SYSTEMS FOR MICROSERVICES OBSERVABILITY AUTOMATION

(71) Applicant: Capital One Services, LLC, McLean, VA (US)

(72) Inventors: Raman Bajaj, Frisco, TX (US); Arjun Dugal, Dallas, TX (US); Sanjiv Yajnik, Dallas, TX (US); Patricia Hansen, Glen Allen, VA (US); Gnanendra Dathathreya, Frisco, TX (US)

(21) Appl. No.: 16/132,233

(22) Filed: Sep. 14, 2018

(51) Int. Cl. H04L 12/26; H04L 29/08; G06F 11/30; G06F 3/048

(52) U.S. Cl. CPC H04L 43/045; H04L 67/22; G06F 2201/865; G06F 11/3003; G06F 3/048; H04L 67/141

(57) ABSTRACT

A monitoring system includes a non-transitory computer readable medium and a processor. The processor receives, in real time, information of an observable item emitted by each stack layer of an observable system according to an observability specification. The observability specification defines the observable item of each stack layer of the observable system to be monitored. The non-transitory computer readable medium stores the received information of the observable item emitted by each stack layer of the observable system. A graphical user interface displays in real time the received information of the observable item emitted by each stack layer of the observable system.

### FIELD

The presently disclosed subject matter relates generally to monitoring, standardizing, and acting based on business and technology metrics and, more particularly, to systems and methods for providing improved microservices observability through automated standardization of emitted business and technology metrics.

### BACKGROUND

Many monitoring tools and solutions in software development that are available today are disjointed and disconnected. Each existing monitoring tool attempts to solve a particular problem leading to tools sprawl. In the existing monitoring tools, multiple user interfaces are used to monitor business metrics, software metrics, infrastructure metrics and handle alerts, resulting in complicated operations and a fragmented customer experience. Metrics are not emitted in real time by systems such as microservices, hence causing out of band and offline analytical solutions for metrics. Further, the existing monitoring tools often require manual creation and configuration of software, tools, dashboards and alerts. Traditionally, distributed developers handle their own microservices. As such, there is a lack of standardization in microservices architecture.

In view of the foregoing, a need exists for a consistent, standard and simplified monitoring solution that automatically monitors business and technology metrics in real time as part of a development lifecycle, and provides easy visualization of various metrics in a simplified view. There is also a need for standardization in microservices architecture, such as standardizing metrics across stack layers, such as technology stack layers, in a scalable enforceable way as part of a continuous integration and continuous delivery (CICD) pipeline. Embodiments of the present disclosure are directed to this and other considerations.

### SUMMARY

Aspects of the disclosed technology include monitoring systems and methods. Consistent with the disclosed embodiments, a monitoring system includes a non-transitory computer readable medium and a processor. The processor receives, in real time, information of an observable item emitted by each stack layer of an observable system according to an observability specification. The observability specification defines the observable item of each stack layer of the observable system to be monitored. The processor stores, in the non-transitory computer readable medium, the received information of the observable item emitted by each stack layer of the observable system. The processor displays, in a graphical user interface, in real time, the received information of the observable item emitted by each stack layer of the observable system.

Another aspect of the disclosed technology relates to a monitoring system that includes a non-transitory computer readable medium and a processor. The processor receives, in real time, information of an observable item emitted by each stack layer of a microservice according to an observability specification. The observability specification defines the observable item of each stack layer of the microservice to be monitored. The processor stores, in the non-transitory computer readable medium, the received information of the observable item emitted by each stack layer of the microservice. The processor aggregates the received information of the observable item emitted by each stack layer of the microservice. The processor displays, in a graphical user interface, in real time, an aggregation of the received information of the observable item emitted by each stack layer of the microservice. The processor detects anomaly in the received information of the observable item emitted by each stack layer of the microservice. The processor performs a remedial action based on the detected anomaly.

A further aspect of the disclosed technology relates to a monitoring system that includes a non-transitory computer readable medium and a processor. The processor receives, in real time, information of observable items emitted by a microservice according to an observability specification. For example, the processor receives information of a first observable item emitted by a business feature layer of the microservice. The processor receives information of a second observable item emitted by an application layer of the microservice. The processor receives information of a third observable item emitted by a container layer of the microservice. The processor receives information of a fourth observable item emitted by a host layer of the microservice. The processor receives information of a fifth observable item emitted by an infrastructure layer of the microservice. The observability specification defines the observable items to be monitored. The processor stores, in the non-transitory computer readable medium, the received information of the observable items emitted by the microservice. The processor aggregates the received information of the observable items emitted by the microservice. The processor displays, in a graphical user interface, in real time, an aggregation of the received information of the observable items emitted by the microservice. The processor detects anomaly in the received information of the observable items emitted by the microservice. The processor performs a remedial action based on the detected anomaly.

Consistent with the disclosed embodiments, methods for performing microservices observability automation to monitor business and technology metrics are disclosed.

Further features of the present disclosure, and the advantages offered thereby, are explained in greater detail hereinafter with reference to specific embodiments illustrated in the accompanying drawings, wherein like elements are indicated by like reference designators.

### BRIEF DESCRIPTION OF THE DRAWINGS

Reference will now be made to the accompanying drawings, which are not necessarily drawn to scale, and which are incorporated into and constitute a portion of this disclosure, illustrate various implementations and aspects of the disclosed technology and, together with the description, explain the principles of the disclosed technology. In the drawings:

FIG. 1 is a diagram of an example environment that may be used to implement one or more embodiments of the present disclosure.

FIG. 2 is an example block diagram illustrating communications between a monitoring system and an observable system according to one aspect of the disclosed technology.

FIG. 3 is an example block diagram illustrating communications among the monitoring system, the observable system and third-party monitoring tools according to one aspect of the disclosed technology.

FIG. 4 is an example flow chart of a process performed by the monitoring system according to one aspect of the disclosed technology.

FIG. 5 is an example flow chart of another process performed by the monitoring system according to one aspect of the disclosed technology.

FIG. 6 is a component diagram of the monitoring system according to one aspect of the disclosed technology.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

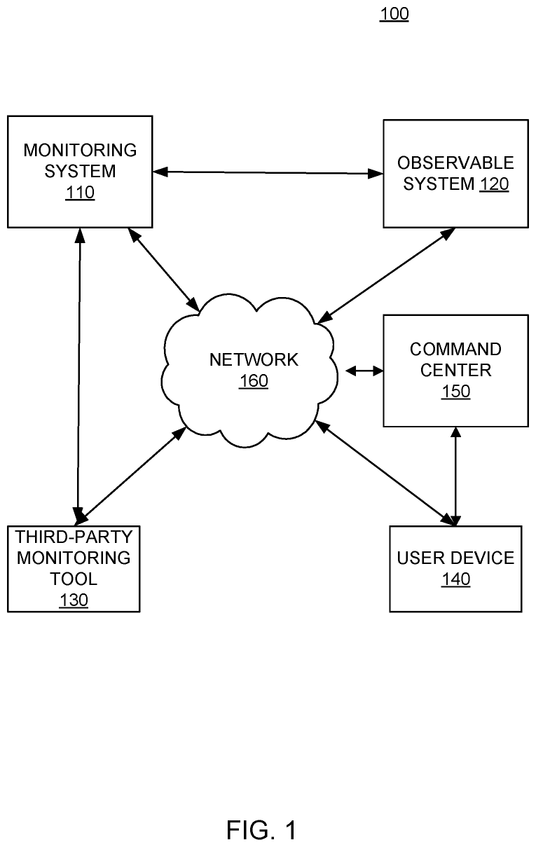

FIG. 1 shows an example environment 100 that may implement certain aspects of the present disclosure. The components and arrangements shown in FIG. 1 are not intended to limit the disclosed embodiments as the components used to implement the disclosed processes and features may vary. As shown in FIG. 1, in some implementations the environment 100 may include one or more of the following: one or more monitoring systems 110, one or more observable systems 120, one or more third-party monitoring tools 130, one or more user devices 140, one or more command centers 150 and one or more networks 160.

Each monitoring system 110 may provide a standard set of monitoring solutions for consistent use. The monitoring system 110 may be configured to perform one or more of the following monitoring capabilities: logging, collection, ingestion, storage, query service, visualization, distributed tracing, alerts, notifications, predictive analysis, anomaly detection, and automated remediation, among other possibilities. The monitoring system 110 may monitor the observable systems 120 for various purposes and applications, including but not limited to, business monitoring, compliance monitoring, and legal monitoring, among other possibilities. The monitoring system 110 may provide insights and metrics on business, application and infrastructure internal state of the observable system(s) 120.

The observable system 120 may be a software system with internal characteristics that may be exposed outside. The observable system 120 may include one or more of the following: one or more microservices, one or more applications and one or more infrastructures.

Each monitoring system 110 may perform real-time monitoring of the observable systems 120. For example, each monitoring system 110 may collect metric data output from the observable systems 120.

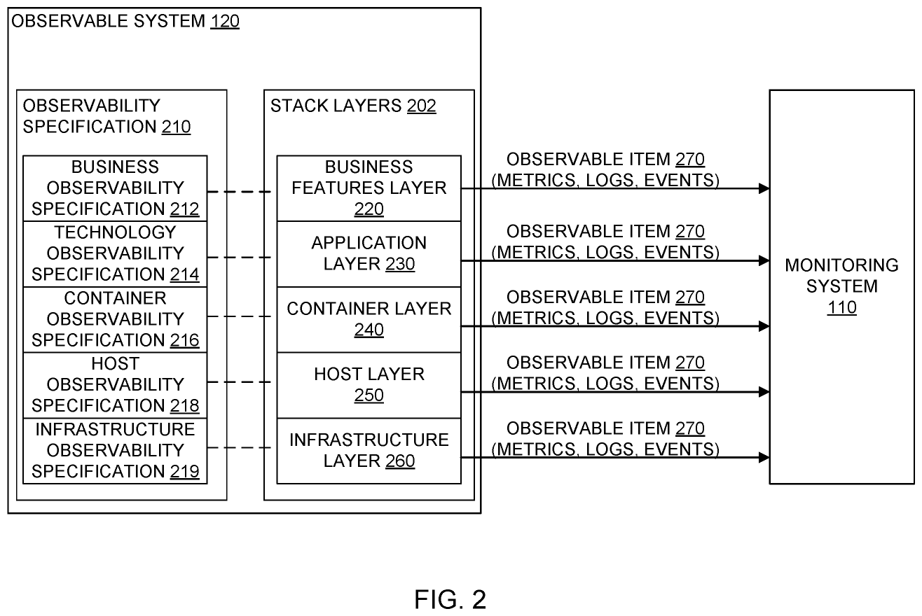

Turning to FIG. 2, the monitoring system 110 may provide monitoring solutions by using one or more observability specifications 210. Each observable system 120 may implement an observability specification 210 across its stack layers 202. Observability specification 210 may include a library of executable functions configured for automating generation (and emitting) of an observable item 270 across each layer 202 of a stack of the observable system 120. Observable items 270 may include one or more of the following: a metric, a log and an event of each stack layer of an observable system 120, such as a microservice. For example, the observability specification 210 may define metrics, logs and events to be emitted by the observable system 120 across each stack layer 202. Example observable items 270 may include, but not limited to, business events, aggregate events, technology metrics, critical to quality (CTQ) metrics, business metrics, regulatory metrics, software metrics, infrastructure metrics, application metrics, digital end user experience, application performance and infrastructure performance, among other possibilities. Each monitoring system 110 may receive information of the observable items 270 from one or more observable systems 120.

The observability specification 210 may automate standardization of metrics across each stack layer 202 in a scalable enforceable way as part of a CICD pipeline. The metrics may be monitored through an automated standardization process. The observability specification 210 may facilitate automation of metrics and conversion of business objectives to observable metrics according to the domain of the observability specification 210.

The observability specification 210 may be configured for particular purposes. In one embodiment, the observability specification 210 may create metrics specifically for testing resiliency or behaviors to suspected outages.

The observability specification 210 may be a modular-plugin based solution that is readily extensible to new requirements.

In some embodiments, each observable system 120 may be configured for emitting in real-time observable items 270 according to observability specification 210, to enable automated monitoring by the monitoring system 110. The configuration of observable system(s) 120 may be part of a continuous integration and continuous delivery (CICD) software development pipeline for deploying the observable system 120. For example, the observable systems 120 may be bootstrapped with particular functionality according to the observability specification 210 in the CICD pipeline. In some embodiments, testing of and compliance verification with the observability specification 210 may be implemented as a control gate in the CICD pipeline.

In one example, the observable system 120 may be a microservice. The microservice may be a software system with its own database that is designed to perform one task, such as any one of the following: handling payments, statements, accounting, decisioning and underwriting, among other possibilities. Multiple microservices handling different tasks may be connected to build a highly distributed and scalable system. The observability specification 210 may be implemented in each microservice in a distributed network. The monitoring system 110 may receive observable items 270 generated from each stack layer 202 of each microservice in the distributed network. The monitoring system 110 may perform one or more of the following monitoring capabilities on the observable items 270: logging, collection, ingestion, storage, query service, visualization, distributed tracing, alerts, notifications, predictive analysis, anomaly detection, and automated remediation, among other possibilities. The monitoring system 110 may present information obtained based on the observable items 270 generated from each stack layer 202 of each microservice in the distributed network in a single pane of glass visualization.

Every layer of the observable system 120, such as the microservice, has an observability specification 210 that describes the metrics important for the layer, and a software solution that emits the metrics. During the CICD cycle of the observable system 120, observability software is injected transparently into layers of the observable system 120 for monitoring automation. The observability specification 210 may specify emitted metrics based on the underlying technology or language. The observability specification 210 may automate standardized generation or emitting of metrics. For instance, various collectors or agents may be bootstrapped based on the particular stack of the observable system 120. The developers no longer need to write any line of monitoring code to get end to end monitoring solution out of the box.

As shown in FIG. 2, the observable system 120, such as a microservice, may include one or more of the following stack layers 202: a business feature layer 220, an application layer 230, a container layer 240, a host layer 250, and an infrastructure layer 260. The observability specification 210 may include one or more of the following specifications tailored to each layer of the microservice: a business observability specification 212, a technology observability specification 214, a container observability specification 216, a host observability specification 218, and an infrastructure observability specification 219.

The business feature layer 220 may have information related to at least one of the following: scheduled payments, created loans, and successful credit pulls, and may provide metrics, logs, and events indicative of the above information. The business observability specification 212 may define metrics, events and logs to be generated by the business feature layer 220. The business observability specification 212 may translate or convert a business metric, a business rule or a legal rule to an observable metric in an automated process.

The application layer 230 may have information related to at least one of the following: threads, connections, heaps, queues and uptime, and may provide metrics, logs, and events indicative of the above information. The technology observability specification 214 may define metrics, events and logs to be generated by the application layer 230. The technology observability specification 214 may translate or convert application metrics to observable metrics in an automated process.

The container layer 240 may have information related to at least one of the following: CPU, memory, and disk and input/output operations per second (IOPS), and may provide metrics, logs, and events indicative of the above information. The container observability specification 216 may define metrics, events and logs to be generated by the container layer 240.

The host layer 250 may have information related to at least one of the following: CPU, memory, disk, file descriptors, uptime, and IPOS, and may provide metrics, logs, and events indicative of the above information. The host observability specification 218 may define metrics, events and logs to be generated by the host layer 250.

The infrastructure layer 260 may have information relates to at least one of the following: elastic load balancing (ELB), S3, and relational database service (RDS), and may provide metrics, logs, and events indicative of the above information. The infrastructure observability specification 219 may define metrics, events and logs to be generated by the infrastructure layer 260.

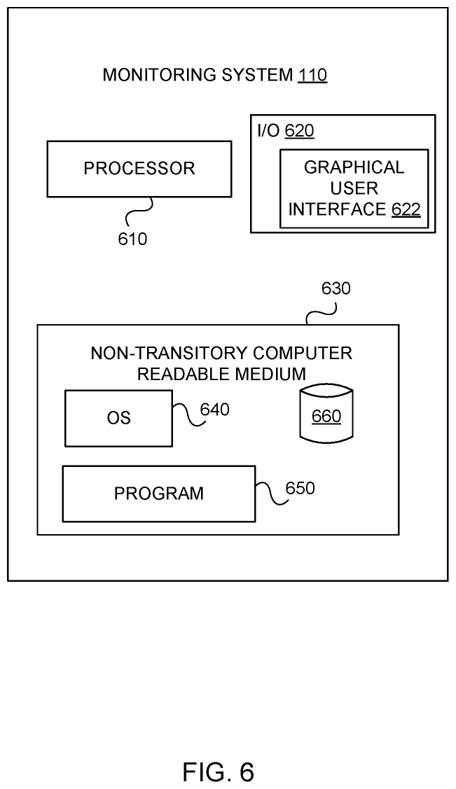

Once the monitoring system 110 receives the metrics, events and logs generated by each stack layer 202, the monitoring system 110 may store such information in one or more metrics libraries. The metrics libraries may be in the form of a non-transitory computer readable medium 630 as shown in FIG. 6. The monitoring system 110 may receive one or more metrics, logs and events obtained from one or more stack layers 202 of the observable system 120. The monitoring system 110 may provide the above information to a user through a graphical user interface 622 as shown in FIG. 6. The graphical user interface 622 may be a single pane of glass visualization.

In some examples, the monitoring system 110 may provide one or more metrics, logs and events obtained from one or more stack layers 202 of the observable system 120 to one or more third-party monitoring tools 130. The graphical user interface 622 provided by the monitoring system 110 may allow the user to select and view information related to any third-part monitoring tool 130, which may include one or more open source and/or cloud native solutions.

Third-party monitoring tools 130 may include one or more existing monitoring solutions that have monitoring capabilities, such as collectors, ingestion, storage/query, visualization, tracing, alerting, notification, auto remediation, and prediction. For example, the third-party monitoring tools 130 may include one or more of the following collector tools: Actuator Spring Boot™, Apica™, AppD™-APM™, EUM™, Biz IQ™, Databox™ visibility, Aternity™ (EUM), Cadvisor™, CloudTrail™, CloudWatch™, ControlM™, Custodian™, Data Dog™, DataXLG-LS™, FileBeat™, F1owLogs™, Host Monitor™, HP OM Agent™, HP Site Scope™, Idera-SQL DB™, Jolokia™, New Relic™, OpenTracing io™, OpNet Agent™, OpsCenter Cassandra™, Oracle OEM™, PinPoint™, Prometheus JVM™, Kafka™, Node Exporter™, RabbitMQ™, Push GW™, Site Catalyst™, Splunk Agent™, StatsD™/CollectD™, TeaLeaf™, Telegraf™, Zabbix™ and ZipKin™, among other possibilities.

The third-party monitoring tools 130 may include one or more of the following ingestion tools: Apica™, AppD™, Aternity™, Cloudtrail™, Cloudwatch™, Datadog™, HostMonitor™, Logstash™, Prometheus™, SDP Kafka™, Splunk™ and Zabbix™, among other possibilities.

The third-party monitoring tools 130 may include one or more of the following storage/query tools: Apica™, AppD™, Cloudtrail™, Cloudwatch™, Datadog™, Elastic Search™, HostMonitor™, InfluxDB™, PinPoint™ (Hbase), Postgres RDS™, Prometheus™, SDP kafka™, S3™, Splunk™, Zabbix™ and ZipKin™, among other possibilities.

The third-party monitoring tools 130 may include one or more of the following visualization tools: Apica™, AppD™, Datadog™, Grafana™, Kibana™, New Relic™, Splunk™, Tableau™ and Zabbix™, among other possibilities.

The third-party monitoring tools 130 may include one or more of the following tracing tools: AppD™, Jaeger Uber™, New Relic™, OpenTrace.io™, PinPoint™, Splunk™ and ZipKin™, among other possibilities.

The third-party monitoring tools 130 may include one or more of the following alerting tools: Apica™, AppD™, CloudWatch™, Control M™, Datadog™, Elastic Search™, HostMonitor™, Kapacitor™, New Relic™, Prometheus™, Sitescope™, Splunk™ and Zabbix™, among other possibilities.

The third-party monitoring tools 130 may include one or more of the following notification tools: Iris™ and Oncall™, MIR3™, PagerDuty™, and VictorOps™, among other possibilities.

The third-party monitoring tools 130 may include one or more of the following auto remediation tools: Automation Anywhere™, Resolve™ and Stackstorm™, among other possibilities.

The third-party monitoring tools 130 may include one or more of the following prediction tools: AppD™, DataDog™ and SciKit™ (Custom), among other possibilities.

The monitoring system 110 may provide metrics to various third-party monitoring tools 130. For example, the monitoring system 110 may provide metrics to collector tools such as Actuator Spring™, Cadvisor™, CloudWatch™, Jolokia™, Prometheus JVM™, Kafka™, Node Exporter™, RabbitMQ™, and Push GW™. The monitoring system 110 may provide metrics to ingestion tools such as Prometheus™ and CloudWatch™. The monitoring system 110 may provide metrics to storage/query tools such as InfluxDB™, Prometheus™ and CloudWatch™. The monitoring system 110 may provide metrics to visualization tools such as Grafana™, tracing tools such as PinPoint™, alerting tools such as Elastic Search™ and Prometheus™, notification tools such as PagerDuty™, auto remediation tools such as Stackstorm™, and prediction tools such as SciKit™.

The monitoring system 110 may provide logs to various third-party monitoring tools 130. For example, the monitoring system 110 may provide logs to collector tools such as FileBeat™, ingestion tools such as Logstash™, storage/query tools such as Elastic Search™, visualization tools as such as Kibana™, tracing tools such as PinPoint™, alerting tools such as Elastic Search™ and Prometheus™, notification tools such as PagerDuty™, auto remediation tools such as Stackstorm, and prediction tools such as SciKit™.

The monitoring system 110 may provide events to various third-party monitoring tools 130. For example, the monitoring system may provide events to collect tools such as SDP Kafka™, ingestion tools such as SDP Kafka™, storage/query tools such as SDP Kafka™ and Postgres RDS™, visualization tools such as Ops™ and Single Pane Glass UI™, tracing tools such as PinPoint™, alerting tools such as Elastic Search™ and Prometheus™, notification tools such as PagerDuty™, auto remediation tools such as Stackstorm, and prediction tools such as SciKit™.

The monitoring system 110 may provide tracing to various third-party monitoring tools 130. For example, the monitoring system may provide tracing to collect tools such as PinPoint™, storage/query tools such as PinPoint™, visualization tools such as PinPoint™, tracing tools such as PinPoint™, alerting tools such as Elastic Search™ and Prometheus™, notification tools such as PagerDuty™, auto remediation tools such as Stackstorm™, and prediction tools such as SciKit™.

In one example, the monitoring system 110 may provide information of observable items 270 received from different stack layers 202 of the observable system 120 to different third-party monitoring tools 130. For instance, the monitoring system 110 may communicate the received information from the container layer 240 to Cadvisor™, communicate the received information from the host layer 250 to Prometheus Node Exporter™, and communicate the received information from the infrastructure layer 260 to Cloud Watch Exporter™.

In one example, the monitoring system 110 may include one or more of the following: Log shipper (File beat™), Container Metrics shipper (Cadvisor™), APM agent (Pinpoint™), Metrics Polling (Prometheus™) and Alerts Rules (Prometheus™ YAML config).

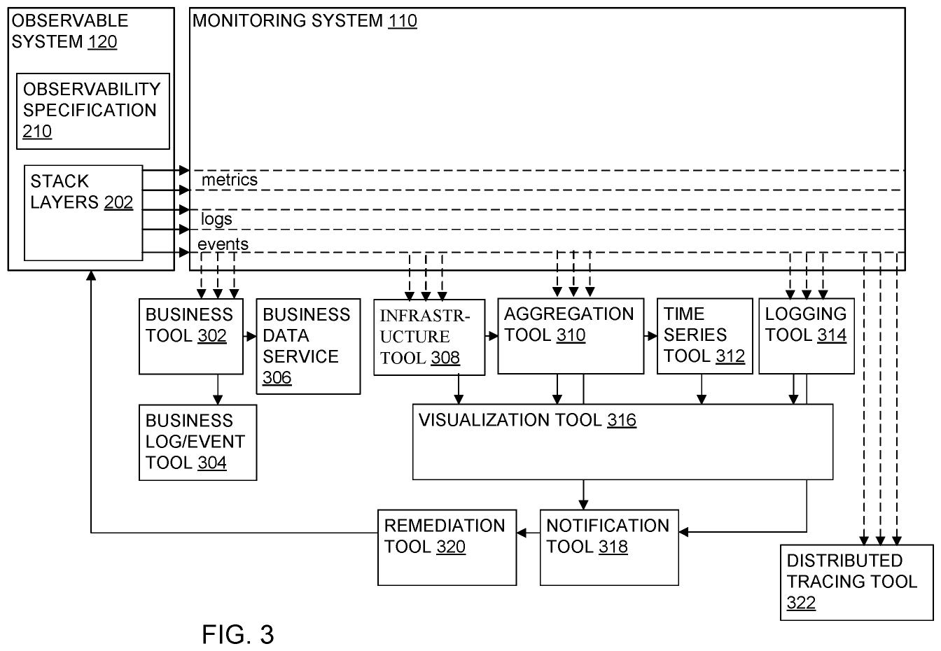

Turning to FIG. 3, in another example, the monitoring system 110 may provide metrics, events, logs to a business tool 302 which processes business related metrics, events and logs. The business tool 302 may send logs and events to a data lake 304, and may also send information to a business data service 306 which may have a database, such as a Postgres™ database. The business tool 302, and the business data service 306 may respectively be an SDP tool, and Ops Data Service™. Further, the monitoring system 110 may provide infrastructure metrics to an infrastructure tool 308 which processes infrastructure metrics. The infrastructure tool 308 may be Cloud Watch™. The infrastructure tool 308 may send information to an aggregation tool 310. The aggregation tool 310 may be Prometheus™. The aggregation tool 310 may receive metrics from the monitoring system 110. The aggregation tool 310 may perform aggregation of metrics, and send information to a time series tool 312 which processes time series information. The time series tool 312 may be InfluxDB™. In addition, the monitoring system 110 may provide logs to a logging tool 314 which processes logging information. The logging tool 312 may be ELK™. Information of the infrastructure tool 308, the aggregation tool 310, the time series tool 312 and the logging tool 314 may be visualized via a visualization tool 316. The visualization tool 316 may be Grafana™. The visualization tool 316 may display information of business and technology related metrics in a single pane of glass visualization. Further, information of the aggregation tool 310 and the logging tool 314 may be sent to a notification tool 318 which handles notification. The notification tool 318 may be Pager Duty™. The notification tool 318 may communicate with a remediation tool 320 which performs auto remediation of the observable systems 120. The remediation tool 320 may be Stack Storm™. Furthermore, the monitoring system 110 may provide tracking information to a distributed tracing tool 322 which handles distributed tracing. The distributed tracing tool 322 may be Pin Point™.

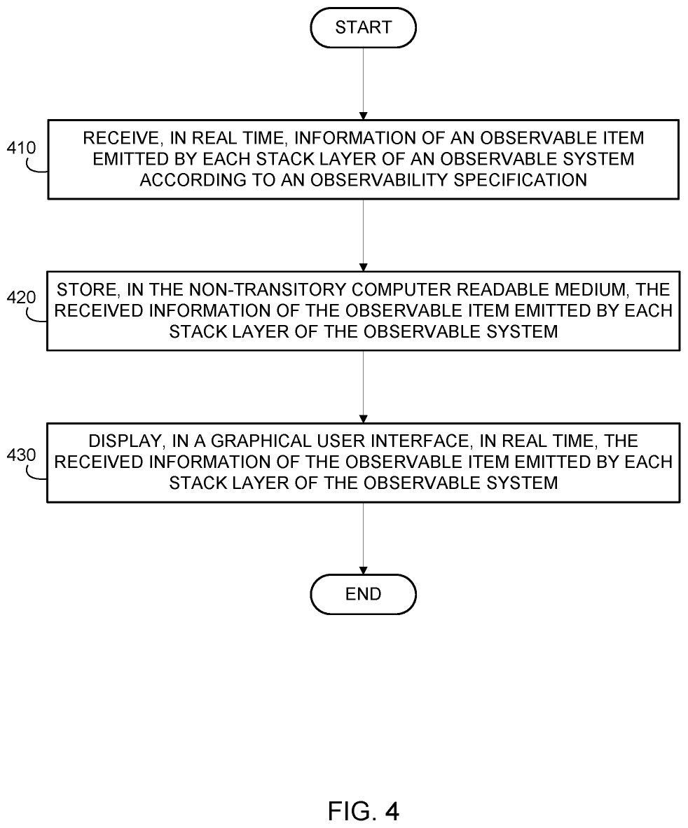

FIG. 4 illustrates an example flow chart of a monitoring process performed by the monitoring system(s) 110. At 410, a processor 610 (or one or more processors, which is used interchangeably with “a” processor in the present disclosure) of the monitoring system 110 may receive, in real time, information of an observable item 270 emitted by each stack layer 202 of the observable system 120 according to an observability specification 210. The observability specification 210 may define the observable item 270 of each stack layer 202 of the observable system 120 to be monitored. At 420, the processor 610 may store, in the non-transitory computer readable medium 630, the received information of the observable item 270 emitted by each stack layer 202 of the observable system 120. At 430, the processor 610 may display, in a graphical user interface 622, in real time, the received information of the observable item 270 emitted by each stack layer 202 of the observable system 120.

Further, the processor 610 may perform one or more of the following: logging, collection, ingestion, storage, query service, visualization, distributed tracing, alerts, notifications, predictive analysis, anomaly detection, and automated remediation. In one example, the observable item 270 may include logs. The processor 210 may analyze the logs, and determine any anomaly in the observable system(s) 120 based on the logs. An anomaly may include, but not limited to, anything wrong in business transactions, legal compliance, and technology stack, among other possibilities. The processor 210 may determine occurrence of an anomaly by comparing the received information of one or more observable items 270 to one or more thresholds. The thresholds may include predetermined values. The processor 210 may determine that an anomaly has occurred when the received information of one or more observable items 270 fail to meet the thresholds. In response, the processor 210 may perform a seal-healing process once an anomaly is detected. For example, when the processor 210 detects that technology resources are getting maxed out, the processor 210 may automatically scale the technology stack without human intervention. The processor 210 may send alerts and/or notifications to one or more operator devices reporting any detected anomaly. When one or more of the observable system(s) 120 goes down, the processor 210 may send alerts and/or notifications, including but not limited to technology alerts, business alerts, and legal and compliance alerts, to the operator device(s). Alerts may be sent to different priority queues, such as mission critical alert queues and informative alert queues. Alerts may be escalated to different priority queues as needed based on severity. The processor 210 may rely on a third-party monitoring tool 130, such as PagerDuty, to send alerts and/or notifications.

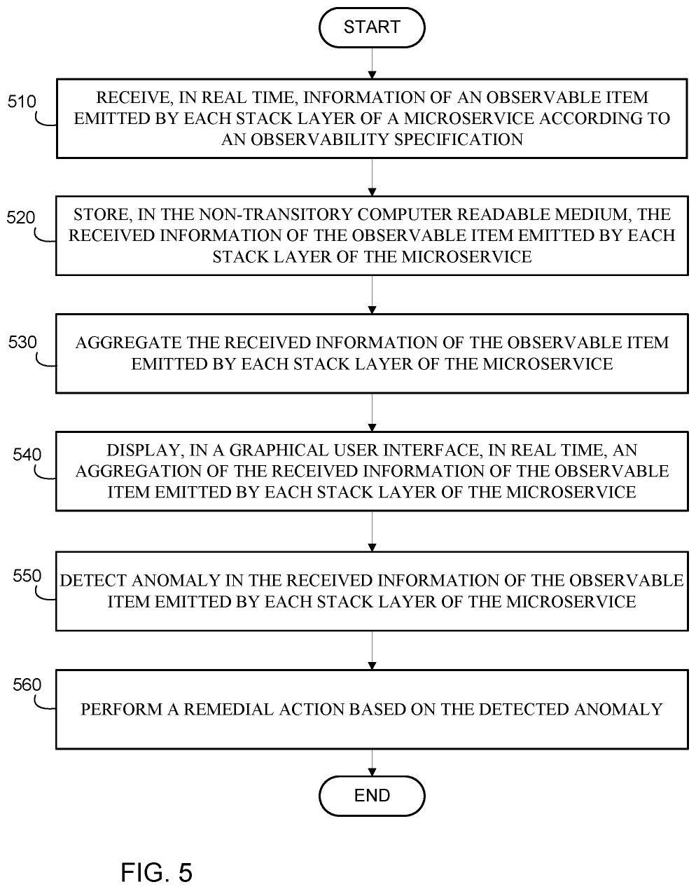

FIG. 5 illustrates another example flow chart of a monitoring process performed by the monitoring system 110. In this example, the observable system 120 may be a microservice. At 510, the processor 210 of the monitoring system 110 may receive, in real time, information of one or more observable items 270 emitted by each stack layer 202 of the microservice according to an observability specification 310. For example, the processor 210 may receive one or more of the following: information of a first observable item 270 emitted by a business feature layer 220 of the microservice, information of a second observable item 270 emitted by an application layer 230 of the microservice, information of a third observable item 270 emitted by a container layer 240 of the microservice, information of a fourth observable item 270 emitted by a host layer 250 of the microservice, and information of a fifth observable item 270 emitted by an infrastructure layer 260 of the microservice. The observability specification 310 may define the observable items to be monitored.

At 520, the processor 210 may store, in the non-transitory computer readable medium 630, the received information of the observable item 270 emitted by each stack layer 202 of the microservice. At 530, the processor 210 may aggregate the received information of the observable item 270 emitted by each stack layer of the microservice. For example, the processor 210 may aggregate business data, legal and compliance data. At 540, the processor 210 may display, in the graphical user interface 622, in real time, an aggregation of the received information of the observable item 270 emitted by each stack layer 202 of the microservice. For instance, the aggregation of the business data, legal and compliance data may be visualized in a single pane of glass. At 550, the processor 210 may detect an anomaly in the received information of the observable item 270 emitted by each stack layer 202 of the microservice. For example, the processor 210 may compare the received information to one or more predetermined thresholds to determine if anything went wrong in the technology stack or the business stack. When the processor 210 determines that one or more thresholds are not met, an anomaly may have occurred. At 560, the processor 210 may perform a remedial action based on the detected anomaly. The processor 210 may send alerts and/or notifications to developer device(s), operator device(s) and/or user device(s) reporting one or more of the detected anomaly and the remedial action(s) performed or being performed.

Each monitoring system 110 and each observable system 120 may be a standalone solution, a network-based client-server solution, a web-based solution, or a cloud-based solution.

FIG. 6 provides a block diagram of an example monitoring system 110 that may implement certain aspects of the present disclosure. Each monitoring system 110 may include one or more physical or logical devices (e.g., servers).

The monitoring system 110 may include the processor 610, an input/output (“I/O”) device 220, the non-transitory computer readable medium 630 containing an operating system (“OS”) 640 and a program 650. For example, the monitoring system 110 may be a single device or server or may be configured as a distributed computer system including multiple servers, devices, or computers that interoperate to perform one or more of the processes and functionalities associated with the disclosed embodiments. In some embodiments, the monitoring system 110 may further include a peripheral interface, a transceiver, a mobile network interface in communication with the processor 610, a bus configured to facilitate communication between the various components of the monitoring system 110, and a power source configured to power one or more components of the monitoring system 110.

A peripheral interface may include hardware, firmware and/or software that enables communication with various peripheral devices, such as media drives (e.g., magnetic disk, solid state, or optical disk drives), other processing devices, or any other input source used in connection with the instant techniques. In some embodiments, a peripheral interface may include a serial port, a parallel port, a general purpose input and output (GPIO) port, a game port, a universal serial bus (USB), a micro-USB port, a high definition multimedia (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, a local area network, or another wide-area network. In some embodiments, a mobile network interface may include hardware, firmware, and/or software that allows the processor(s) 210 to communicate with other devices via wired or wireless networks, whether local or wide area, private or public, as known in the art. A power source may be configured to provide an appropriate alternating current (AC) or direct current (DC) to power components.

The processor 610 may include one or more of a microprocessor, microcontroller, digital signal processor, co-processor or the like or combinations thereof capable of executing stored instructions and operating upon stored data. The processor 610 may be one or more known processing devices, such as a microprocessor from the Pentium™ family manufactured by Intel™ or the Turion™ family manufactured by AMD™. Processor 610 may constitute a single core or multiple core processor that executes parallel processes simultaneously. For example, processor 610 may be a single core processor that is configured with virtual processing technologies. In certain embodiments, processor 610 may use logical processors to simultaneously execute and control multiple processes. Processor 610 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

Once the monitoring system 110 receives metrics, events and logs generated by each layer of the observable system 120, the monitoring system 110 may store such information in one or more metrics libraries within the non-transitory computer readable medium 630. The non-transitory computer readable medium 630 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein are implemented as a combination of executable instructions and data within the non-transitory computer readable medium 630. The non-transitory computer readable medium 630 may include one or more memory devices that store data and instructions used to perform one or more features of the disclosed embodiments. The non-transitory computer readable medium 630 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The non-transitory computer readable medium 630 may include software components that, when executed by processor 610, perform one or more processes consistent with the disclosed embodiments. In some embodiments, the non-transitory computer readable medium 630 may include a database 660 to perform one or more of the processes and functionalities associated with the disclosed embodiments. The non-transitory computer readable medium 630 may include one or more programs 650 to perform one or more functions of the disclosed embodiments. Moreover, the processor 610 may execute one or more programs 650 located remotely from the monitoring system 110. For example, the monitoring system 110 may access one or more remote programs 650, that, when executed, perform functions related to disclosed embodiments.

The monitoring system 110 may also include one or more I/O devices 620 that may comprise one or more interfaces for receiving signals or input from devices and providing signals or output to one or more devices that allow data to be received and/or transmitted by the monitoring system 110. For example, the monitoring system 110 may include interface components, which may provide interfaces to one or more input devices, such as one or more keyboards, mouse devices, touch screens, track pads, trackballs, scroll wheels, digital cameras, microphones, sensors, and the like, that enable the monitoring system 110 to receive data from one or more users. The monitoring system 110 may include a display, a screen, a touchpad, or the like for displaying images, videos, data, or other information. The I/O devices 620 may include the graphical user interface 622. The graphical user interface 222 may be a single pane of glass visualization.

In exemplary embodiments of the disclosed technology, the monitoring system 110 may include any number of hardware and/or software applications that are executed to facilitate any of the operations. The one or more I/O interfaces 620 may be utilized to receive or collect data and/or user instructions from a wide variety of input devices. Received data may be processed by one or more computer processors as desired in various implementations of the disclosed technology and/or stored in one or more memory devices.

Turning back to FIG. 1, the user devices 140 in the system environment 100 may each be a personal computer, a smartphone, a laptop computer, a tablet, or other personal computing device. Each user device 140 may run and display one or more applications. In certain implementations according to the present disclosure, the user device 140 may include one or more applications and/or one or more processors. The one or more applications may provide a graphical display including a field for a user to enter a request to access code associated with a web page. The user request may include a uniform resource locator (URL). In some cases, the user request may be a request to run and/or access one or more web-based applications to be executed on one or more monitoring systems 110 and one or more observable systems 120. User device 140 can include one or more of a mobile device, smart phone, general purpose computer, tablet computer, laptop computer, telephone, PSTN landline, smart wearable device, voice command device, other mobile computing device, or any other device capable of communicating with network 160 and ultimately communicating with one or more monitoring systems 110 and/or one or more observable systems 120. According to some embodiments, user device 140 may communicate with one or more monitoring systems 110 and one or more observable systems 120 via the network 160.

The networks 160 may include a network of interconnected computing devices more commonly referred to as the internet. Network 160 may be of any suitable type, including individual connections via the internet such as cellular or WiFi networks. In some embodiments, network 160 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security. Network 160 may comprise any type of computer networking arrangement used to exchange data. For example, network 106 may be the Internet, a private data network, virtual private network using a public network, and/or other suitable connection(s) that enables components in system environment 100 to send and receive information between the components of system 100. Network 160 may also include a public switched telephone network (“PSTN”) and/or a wireless network. The network 160 may also include local network that comprises any type of computer networking arrangement used to exchange data in a localized area, such as WiFi, Bluetooth™ Ethernet, and other suitable network connections that enable components of system environment 100 to interact with one another.

The command center 150 may receive alerts and/or notifications generated by the monitoring system 110. The command center 150 may be operated by developers and/or operators. The command center 150 may send further alerts and/or notifications to the user device 140.

### Exemplary Use Cases

The following example use case describes examples of particular monitor implementations. This is intended solely for explanatory purposes and not limitation.

In one example, one of the observable systems 120, such as a microservice, handles credit card payments. The microservice is bootstrapped with an observability specification 210 that defines observable items 270 such as metrics needed for monitoring business transactions. The observability specification 210 may handle conversion of business or legal rules to metrics to be emitted according to library functions of the observability specification 210. In one instance, the monitoring system 110 may store a predetermined threshold indicating an acceptable number of payments on each day, such as 2000 payments a day. When the monitoring system 110 receives information of an observable item 270, such as a metric, from the microservice that indicates 50 payments a day, the monitoring system 110 may compare the received information with the predetermined threshold and determine that an anomaly has occurred. The monitoring system 110 may send an alert to a command center 150 indicating that something is wrong in the business operation.

In an additional example, a user makes a mobile payment through the user device 140. The monitoring system 110 may detect in real time that the payment fails to complete. The monitoring system 110 may send an alert in real time to the command center 150 to re-engage with the user (e.g., via the user device 140) to make sure that the user completes the payment process. Traditional batch systems do not provide such alerts in real time, as the batch system has to run overnight to detect incomplete payments.

In one example, the monitoring system 110 tracks statement payment by customers. A statement is sent out 21 days before its due date. The monitoring system 110 may monitor payment status as the due dates approach. The monitoring system 110 may notify the customers when approaching the 17th days.

In one example, an observable system 120 such as a microservice handles statement payments. To avoid multiple payments by the same customer on a single day, an observability specification 210 may include metrics configured to watch for any second payment on the due date, or metrics configured to watch for second payment during a 30-day period. When the monitoring system 110 detects a second payment based on the metrics received from the microservice, the monitoring system 110 may send an alert to the command center 150, or send an alert to the customer (e.g., via the user device 140) about the second payment.

In another example, the monitoring system 110 may detect duplicate payments by the same customer. The monitoring system 110 may send real-time alerts when a microservice starts to process duplicate payments.

In another example, a microservice handles a loan fulfillment process. The monitoring system 110 may monitor oversubscription of any business fulfillment part. The monitoring system 110 may store one or more predetermined thresholds indicating acceptable loan volume by each business fulfillment part. Based on metrics received form the microservice, the monitoring system 110 may determine that a business fulfillment part is oversubscribed by loan volume. The monitoring system 110 may generate a business alert indicating that the loan cannot be assigned to the specific business fulfillment part, and it has to be assigned to a different business fulfillment part.

In yet another example, the monitoring system 110 may store predetermined thresholds indicating a maximum consumption of a CPU of a microservice, such as 90% of the CPU, and a maximum consumption of memory of the microservice, such as 80% of the memory. The microservice is bootstrapped with the observability specification 210 that defines metrics needed for monitoring CPU and memory consumption. When the monitoring system 110 receives metrics from the microservice that indicates CPU and memory consumption in excess of the predetermined thresholds of the maximum consumption of CPU and memory, the monitoring system 110 may send an alert to a technology monitoring team (e.g., to the command center 150). As an alternative to, or in addition to, sending alerts, when the monitoring system 110 determines that technology resources are maxed out, the monitoring system 110 may automatically scale the technology stack of the microservice without any human intervention.

In an additional example, a microservice needs to be always in an operation mode. When the monitoring system 110 determines that the microservice is down, such as during a power outage, the monitoring system 110 may generate a mission critical alert to a technology team (e.g., to the command center 150) in five minutes or less, along with all relevant information for the technology team to diagnose the issue. Such relevant information includes loggings, distributed tracing details, CPU utilization, memory, thread counts, connection pool, and any other information that is required to perform the diagnosis.

The disclosed technology provides a first-class monitoring solution incorporated as part of a development lifecycle. Metrics are defined and emitted in real-time using the observability specification 210 for both business and technology domains as part of the development lifecycle. The observability specification 210 defines metrics and automation for emission, and brings together business and technology metrics in a single pane for visualization along with logs and tracing for operations.

The monitoring system 110 provides a single pane of glass visualization for business and technology metrics to simplify operations, offering a consistent and standard monitoring solution for every observable system 120, such as every microservice. The monitoring system 110 may provide context aware links from standard metrics dashboard to logging and tracing solution, accelerating troubleshooting experience.

Through the observability specification 210 and the monitoring system 110, the disclosed technology presents a solution to automatically create real-time business metrics, technology metrics, and provide visualization, alerts and notification to developers, operators and/or users through a self-service automation process.

By using the disclosed technology, the developers no longer need to write any line of monitoring code to get end to end monitoring solution out of the box. Every layer of the observable system 120, such as the microservice, has an observability specification 210 that describes the metrics important for the layer, and a software solution that emits the metrics. During the CICD cycle of the observable system 120, observability software is injected transparently into layers of the observable system 120 for monitoring automation. The disclosed technology provides logging, distributed tracing, real-time metrics, alerts, notification and visualization all as automated services. The disclosed technology provides irresistible developer experiences, increased productivity, increased observability of applications, and consistency in operations.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some implementations of the disclosed technology.

These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

Implementations of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A monitoring system, comprising:
a non-transitory computer readable medium; and
a processor configured to:
receive information of a first observable item automatically emitted, in real time, by a first stack layer of a microservice according to a first observability specification and a second observable item automatically emitted, in real time, by a second stack layer of the microservice according to a second observability specification, the first observability specification defining the first observable item of the first stack layer and the second observability specification defining the second observable item of the second stack layer of the microservice to be monitored, each observability specification including a library of executable functions that automates emitting of the information of each observable item, the microservice being initially loaded with the first and second observability specifications in a continuous integration and continuous delivery pipeline that deploys the microservice;
store, in the non-transitory computer readable medium, the received information of the respective observable items emitted by the first and second layers of the microservice;
display, in a graphical user interface, in real time, the received information of the observable items emitted by the first and second layers of the microservice;
automatically detect an anomaly in the received information of at least one of the observable items; and
automatically send an instruction to the stack layer of the microservice from which the at least one of the observable items containing the detected anomaly is emitted to resolve the anomaly without human intervention.

2. The monitoring system of claim 1, wherein the first stack layer includes a business feature layer, the second stack layer includes an application layer, the first observable item relates to a business metric, and the second observable item relates to a technology metric.

3. The monitoring system of claim 1, wherein each observable item includes one or more of the following: a metric, a log and an event of each stack layer of the observable system.

4. The monitoring system of claim 1, wherein each observable item includes one or more of the following: business events, aggregate events, technology metrics, critical to quality (CTQ) metrics, business metrics, regulatory metrics, software metrics, infrastructure metrics, application metrics, digital end user experience, application performance and infrastructure performance.

5. The monitoring system of claim 1, wherein the processor performs one or more of the following: logging, collection, ingestion, storage, query service, visualization, distributed tracing, alerts, notifications, predictive analysis, anomaly detection, and automated remediation.

6. A monitoring system, comprising:
a non-transitory computer readable medium; and
a processor configured to:
receive information of business observable metric automatically emitted, in real time, by a business stack layer of a microservice according to a first observability specification and a technology observable metric automatically emitted, in real time, by an application stack layer of the microservice according to a second observability specification, the microservice being initially loaded with the first and second observability specifications in a continuous integration and continuous delivery pipeline that deploys the microservice, the first observability specification defining the business observable metric of the business stack layer, the second observability specification defining the technology observable metric of the application layer of the microservice to be monitored, each observability specification including a library of executable functions that automates emitting of the information of each observable metric;
store, in the non-transitory computer readable medium, the received information of the business observable metric and the technology observable metric emitted by the business stack layer and the application stack layer of the microservice;
display, in a graphical user interface, in real time, the received information of the business observable metric and the technology observable metric emitted by the business stack layer and the application stack layer of the microservice;
automatically detect anomaly in the received information of at least one of the business observable metric and the technology observable metric; and
perform a remedial action based on the detected anomaly, including automatically send an instruction to the stack layer of the micro service from which the at least one of the business observable metric or the technology observable metric containing the detected anomaly is emitted to resolve the anomaly without human intervention.

7. The monitoring system of claim 6, wherein the received information further includes:
a container observable metric emitted by a container stack layer of the microservice,
a host observable metric emitted by a host stack layer of the microservice, and
an infrastructure observable metric emitted by an infrastructure stack layer of the microservice,
wherein the microservice is initially loaded with additional observability specifications that defines the container metric of the container stack layer, the host metric of the host stack layer, and the infrastructure metric of the infrastructure stack layer of the microservice to be monitored.

8. The monitoring system of claim 6, wherein the business observable metric relates to at least one of the following: scheduled payments, created loans, and successful credit pulls.

9. The monitoring system of claim 6, wherein the technology observable metric relates to at least one of the following: threads, connections, heaps, queues and uptime.

10. The monitoring system of claim 7, wherein the container observable metric relates to at least one of the following: CPU, memory, disk, and input/output operations per second (IOPS).

11. The monitoring system of claim 7, wherein the host observable metric relates to at least one of the following: CPU, memory, disk, file descriptors, uptime and IPO.

12. The monitoring system of claim 7, wherein the infrastructure observable metric relates to at least one of the following: elastic load balancing (ELB), S3, and relational database service (RDS).

13. The monitoring system of claim 6, wherein the received information further includes one or more of the following: a log and an event of each stack layer of the microservice.

14. The monitoring system of claim 6, wherein the processor is configured to perform one or more of the following: logging, distributed tracing and notification.

15. A monitoring system, comprising:
a non-transitory computer readable medium; and
a processor configured to:
receive observable metrics automatically emitted, in real time, by a microservice, including:
receiving a plurality of business observable metrics automatically emitted, in real time, by a business feature layer of the microservice according to a business observability specification which automatically converts one or more metrics of the business feature layer to the business observable metrics;
receiving a plurality of technology observable metrics automatically emitted, in real time, by an application layer of the microservice according to a technology observability specification which automatically converts one or more metrics of the application layer to the technology observable metrics;
receiving a plurality of container observable metrics automatically emitted, in real time, by a container layer of the microservice according to a container observability specification which automatically converts one or more metrics of the container layer to the container observable metrics;
receiving a plurality of host observable metrics automatically emitted, in real time, by a host layer of the microservice according to a host observability specification which automatically converts one or more metrics of the host layer to the host observable metrics;
receiving a plurality of infrastructure observable metrics automatically emitted, in real time, by an infrastructure layer of the microservice according to an infrastructure observability specification which automatically converts one or more metrics of the infrastructure layer to the infrastructure observable metrics,
wherein the microservice is initially loaded with each observability specification in a continuous integration and continuous delivery pipeline that deploys the microservice, each observability specification including a library of executable functions that automates emitting of the observable metrics;
store, in the non-transitory computer readable medium, the received observable metrics emitted by the microservice;
display, in a graphical user interface, in real time, the observable metrics emitted by the microservice;
detect anomaly in at least one of the observable items metrics emitted by the microservice;
identify the layer of the microservice from which the at least one of the observable metrics containing the detected anomaly is emitted; and
perform a remedial action based on the detected anomaly, including automatically send an instruction to the identified layer to resolve the anomaly without human intervention.

16. The monitoring system of claim 15, wherein the business observable metric relates to at least one of the following: scheduled payments, created loans, and successful credit pulls.

17. The monitoring system of claim 15, wherein the technology observable metric relates to at least one of the following: threads, connections, heaps, queues and uptime.

18. The monitoring system of claim 15, wherein the container observable metric relates to at least one of the following: CPU, memory, disk, and input/output operations per second (IOPS).

19. The monitoring system of claim 15, wherein the host observable metric relates to at least one of the following: CPU, memory, disk, file descriptors, uptime and IPO.

20. The monitoring system of claim 15, wherein the infrastructure observable metric relates to at least one of the following: elastic load balancing (ELB), S3, and relational database service (RDS).

21. The monitoring system of claim 1, wherein the processor is configured to:
receive information of a plurality of observable items automatically emitted, in real time, by a plurality of stack layers of a second microservice according to a plurality of observability specifications, each observability specification defining an observable item of one of the stack layers of the second microservice to be monitored, each observability specification including a library of executable functions that automates emitting of the information of each observable item, the second microservice being initially loaded with the observability specifications in a continuous integration and continuous delivery pipeline that deploys the second microservice;
store, in the non-transitory computer readable medium, the received information of the respective observable items emitted by the first and second layers of the second microservice;
display, in the graphical user interface, in real time, the received information of the observable items emitted by the first and second layers of the second microservice;
automatically detect an anomaly in the received information of at least one of the observable items emitted by the first and second layers of the second microservice;
identify the stack layer of the second microservice from which the at least one of the observable items containing the detected anomaly is emitted; and
automatically send an instruction to the identified stack layer of the second microservice to resolve the anomaly without human intervention.
